(19) United States
(12) Patent Application Publication
(10) Pub. No.: US 2010/0128596 A1
(43) Pub. Date: May 27, 2010

(54) TRANSMISSION APPARATUS

(75) Inventor: Satoru SAITOH, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/622,582

(22) Filed: Nov. 20, 2009

(30) Foreign Application Priority Data
Nov. 27, 2008 (JP) 2008-301917

(51) Int. Cl. H04L 12/26; G06F 11/00

(52) U.S. Cl. 370/216; 370/242

(57) ABSTRACT

There is provided a transmission apparatus being operable to realize a link capacity adjustment scheme (LCAS) between a plurality of nodes forming a network over which signals are transmitted by using a virtual concatenation (VCAT) system, the transmission apparatus including a receiving part being operable to detect a failure of a member as a transmission path forming a virtual concatenation group (VCG) in each member, and a controller being operable to control setting of detection conditions of the failure received at the receiving part in each member.

### CROSS-REFERENCE TO RELATED APPLICATION

This application is based upon and claims the benefit of priority of the prior Japanese Patent Application No. 2008-301917, filed on Nov. 27, 2008, the entire contents of which are incorporated herein by reference.

### FIELD

The embodiments discussed herein are related to a transmission apparatus that realizes a LCAS (Link Capacity Adjustment Scheme) between a plurality of nodes forming a network over which signals are transmitted by using a VCAT (Virtual Concatenation) system.

### BACKGROUND

An LCAS technique makes it possible to dynamically change (increase/eliminate) the band of VCAT standardized by G.707/Y.1322 of ITU-T (TELECOMMUNICATION STANDARDIZATION SECTOR OF INTERNATIONAL TELECOMMUNICATION UNION) as being standardized by G.7042/Y.1305 of ITU-T, and to change the band without stopping traffic with respect to failure of a path level. AIS-P (alarm indication signal of path), UNEQ-P (unequipped of path), PLM-P (payload label mismatch of path), TIM-P (trace identifier mismatch of path), excessive bit error of the path, signal degrade of the path, LOM (loss of multiframe) (multi frame abnormality of VCAT), MND (member not deskewable) (excessive of delay of a part of member when LCAS is executed), and the like are included in the failure detected at the path level. By such a failure detection, a path that is not used as a member of LCAS is automatically separated, and a scheme capable of managing by the remaining member is equipped in a transmission device (for example, Japanese Laid-open Patent Publication No. 2002-359627, Japanese Laid-open Patent Publication No. 2006-013562).

On the other hand, in a transmission apparatus forming such as SONET/SDH (Synchronous Optical Network/Synchronous Digital Hierarchy) system, since the transmission apparatus has a protection band on transmission lines that protects the path, when failure is temporally generated, there is a case that restoration is possible by a path changing of SONE/SDH system. In ITU-T Rec. G.7042/Y.13051 or ITU-T Rec. G.808.1, it is recommended to provide means for not detecting failure for a constant time in a high-order layer by using a HOLD OFF Timer (HO timer) to wait time till failure detection is determined so that unused switching of the path are not generating on the high-order layer (for example, LCAS) with respect to such a protection system using the path switching.

### SUMMARY

According to an aspect of the embodiment, there is provided a transmission apparatus being operable to realize a link capacity adjustment scheme (LCAS) between a plurality of nodes forming a network over which signals are transmitted by using a virtual concatenation (VCAT) system, the transmission apparatus including a receiving part being operable to detect a failure of a member as a transmission path forming a virtual concatenation group (VCG) in each member, and a controller being operable to control setting of detection conditions of the failure received at the receiving part in each member.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overall view of a network according to embodiments;

FIG. 2 is a diagram illustrating a configuration example of failure detection;

FIG. 3 is a time chart illustrating a service band according to data transfer in the case where there is no HO timer;

FIG. 4 is a time chart illustrating a service band in the case where there is a protection in a transmission line and an HO timer is applied;

FIG. 5 is a time chart illustrating a service band in the case where there is no protection in a transmission line and an HO timer is applied;

FIG. 6 is a diagram illustrating a setting in the case where a line whose failure is restored and a line whose failure is not restored are used in LCAS in a transmission line of a BLSR system;

FIG. 7 is a time chart illustrating a service band when failure is generated in a transmission line in the network of FIG. 6;

FIG. 8 is a time chart illustrating a service band in the case where a bit error is called off after the bit error is detected; and

FIG. 9 is a diagram illustrating an example in which a transmission apparatus is involving with a protection of a transmission line.

### DESCRIPTION OF EMBODIMENTS

In the case of using the HO timer system standardized by ITU-T Rec. G.7042/Y.13051 or ITU-T Rec. G.808.1, there is a case in that a path relief is not executed by LCAS for the time related to the HO timer without exception also for a path that is not restored from failure (for example, path which is excluded from a target of protection in a transmission line such as a standby path). In order to improve the case, there may be a method for setting the HO timer shorter. However, in this case, it is judged that the path which may be normally relieved by the protection of the transmission line has failure in the LCAS in the middle of path relief, and the unused switching of the path are generating.

Currently, since normal failure restoration time in SONET/SDH system is within 50 msec, the value of the HO timer exceeds 50 msec, and since it is desirable that the time is not too long, the value of the HO timer is set to, for example, 100 msec. In this case, when failure is generated in the path which is managed by LCAS and which is not a target of redundancy relief in the transmission line, although the path is ideally relieved by LCAS immediately after failure detection, a processing of restoration by LCAS is executed after 100 msec is passed.

Further, since a detection algorism of excessive bit error of the path is a temporally dispersed detection system, it is unlikely that the timing detected in the middle of the network and the timing detected by a transmission apparatus of a terminal node in order to use in LCAS are matched. Consequently, there is a case that the HO timer is not useful.

It is required to immediately execute relief of the path when required without generating unused switching of the path in the transmission apparatus that realizes LCAS.

### First Embodiment

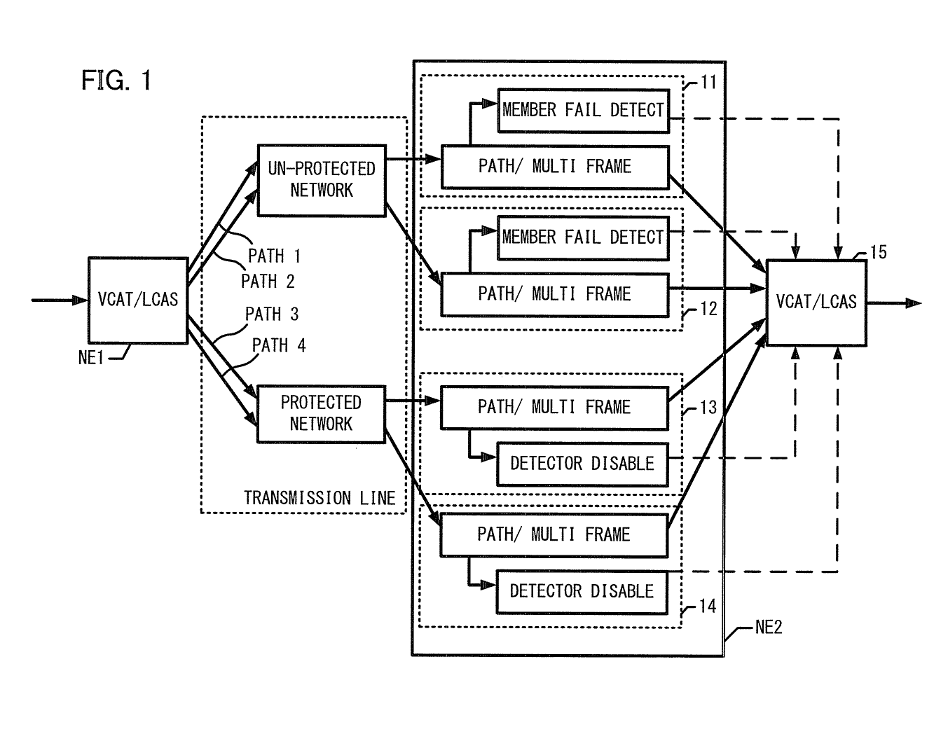

FIG. 1 is a diagram illustrating an overall view of a network according to embodiments. In FIG. 1, a state in which data is transferred in the direction from a transmission apparatus NE1 to a transmission apparatus NE2 is illustrated. The transmission apparatus NE1 equipped in a node is an apparatus that executes VCAT established according to the standard, and is an apparatus in which LCAS is mounted. In the example, data is transferred by using four paths formed in a transmission line connecting with NE1 and NE2. Note that the configuration of a transmission (LCAS source) side of a VCAT/LCAS portion in the transmission apparatuses NE1, NE2 is standard and the detail will be omitted.

The transmission line of the embodiment is included in a transmission network formed by SONET, and among the four paths used in the VCAT, two paths PATH1, PATH2 are formed on a transmission line having no protection system (un-protected network), and the remaining two paths PATH3, PATH4 are formed on a transmission line having a protection system (protected network), and are connected to the transmission apparatus NE2. The receiving (LCAS sink) side of a VCAT/LCAS portion in the transmission apparatus NE2 is an apparatus mounting a VCAT/LCAS, and by the LCAS control unit 11, 12, 13, 14, member failure detection conditions are set for every path which is a member. Note that, reference numeral 10 is used to denote the LCAS control unit as a generic name. And the LCAS control unit 10 includes a receiving part that receives path signals and multi frame signals and is operable to detect the failure of the member as the transmission path forming a virtual concatenation group (VCG) every the members and a controller that is operable to control setting of detection conditions of the failure received at the receiving part every the members.

In the drawing, the LCAS control units 11, 12 for the paths PATH1, PATH2 are set to execute detection of member failure (MSU-L: Member Signal Unavailable LCAS-enabled criteria) (Member fail detect, refer to FIG. 1). The LCAS control units 13, 14 for the Path PATH3, PATH4 are set not to execute detection of member failure (Detector disable, refer to FIG. 1). Further in the case of the embodiment, as for the PATH1, PATH2 that do not have a protection system, the detection of member failure is executed without a waiting time (HO timer: Hold Off timer) for determining failure detection in order to execute line restoration by the LCAS at a high speed. That is, since there is no protection in paths PATH1, PATH2, there is no expectation that failure is restored by the protection processing of transmission line. Accordingly, failure restoration capability is given on the LCAS by normally executing failure detection of the LCAS member by the transmission apparatus NE2 and by notifying the transmission side of a state of the path (member status: MST) as Fail in accordance with the LCAS standard (that is, MST=FAIL is notified.). On the other hand, the PATH3, PATH4 which are set not to execute detection of member failure in the LCAS have a protection processing of transmission line, so that failure restoration is expected at about 50 msec by the protection of transmission line. Consequently, in order not to execute a needless switching in the LCAS, detection of member failure is stopped and the member status of Fail (MST=FAIL) is not notified.

As a result, it is prevented that a restoration operation of a low speed of the LCAS is uselessly activated for the relieving of the transmission line having a protection, and the original relieving function by the LCAS is executed to the failure in the transmission line having no protection while restraining the delaying of the relieving function by the LCAS by the HO timer.

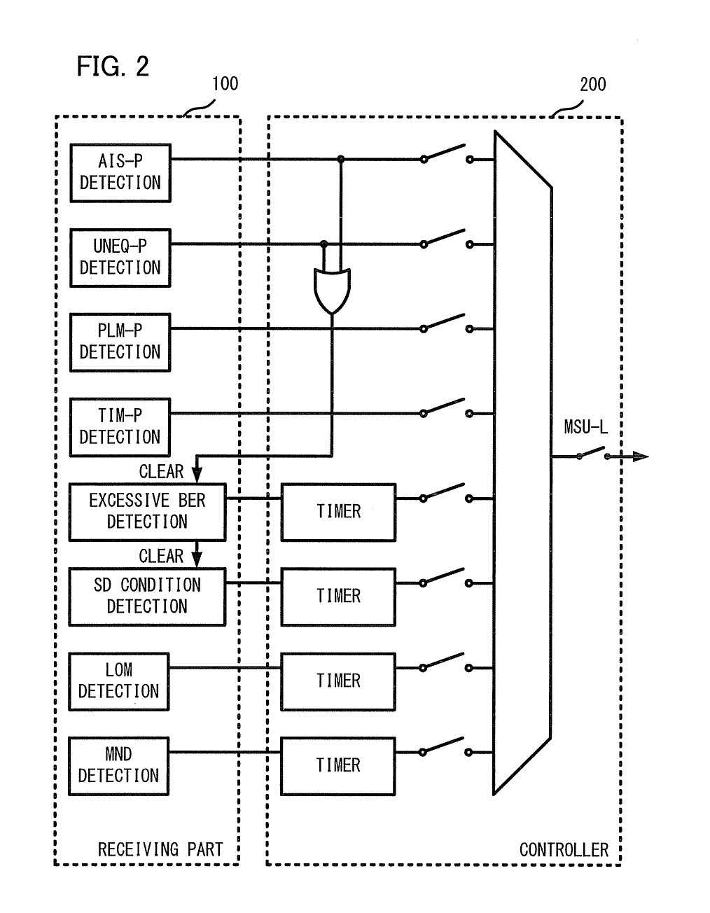

FIG. 2 is a diagram illustrating a configuration example of failure detection for every member (path) in the LCAS control unit 10. LCAS control unit 10 includes a receiving part 100 and a controller 200. The receiving part 100 receives a transmission signal having path signals and multi frame signals, detects failures of every kind of the member. The controller 200 is operable to control setting of detection conditions of the failures of every kind received at the receiving part 100 every the members.

AIS-P (Path Alarm Indication Signal), UNEQ-P (Path Unequipped), PLM-P (Path Payload Label Mismatch), and TIM-P (Path Trace Identifier Mismatch) are alarms of the path detected in SONET/SDH. Excessive bit error (excessive BER) of the path, signal degrade (SD condition) of path are detected when exceeded a predetermined bit error rate threshold value in the SONET/SDH. As for detection of the excessive bit error and signal degrade, it is settable whether or not a timer that sets a waiting time till detection of failure is determined and a waiting time till failure state is called off is operated. Further, when the AIS-P, UNEQ-P are detected, it is settable that the state of the excessive bit error, signal degrade are cleared. Also the failure of LOM, MND is detected by the receiving part of LCAS control unit 10. As for the LOM, MND, it is settable whether or not a timer related to a waiting time till detection of failure is determined and a waiting time till failure state is called off is operated.

The detection information of each failure is transmitted to an MSU-L setting part (detection setting part of member failure) of the member vial a switch for setting whether or not to be regarded as member failure detection conditions. The MSU-L setting part outputs a signal to a VCAT/LCAS processing part 15 via a switch for setting whether or not the whole member failure detection is regarded as valid. The LCAS control unit 10 may be constituted by any of hardware, software, or a combination thereof.

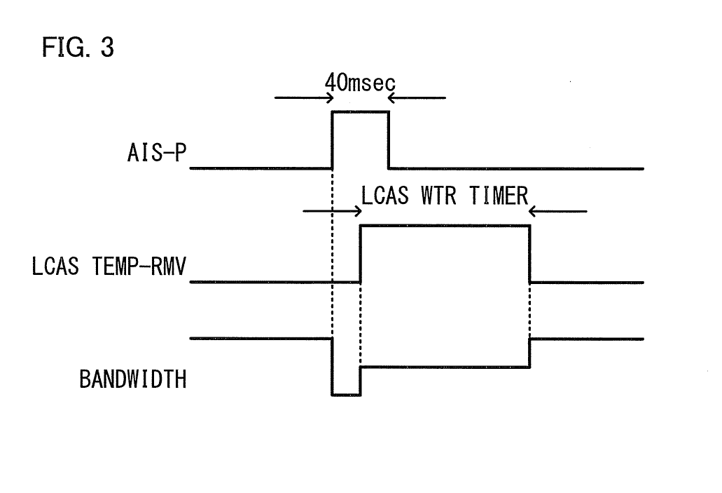

An operation of the transmission apparatus NE2 in the embodiment will be described by comparing with a normal operation. First, FIG. 3 to FIG. 5 are diagrams illustrating each a time chart related to using of the HO timer.

FIG. 3 is a time chart illustrating a service band according to data transfer in the case where there is no HO timer. The state in the middle of the network is omitted, and the state at the receiving (LCAS sink) side when failure is generated is illustrated with a time chart. In the example, the state is illustrated in which AIS-P is generated, path is switched by the protection of the transmission line after 40 msec thereof, and the failure is restored.

With generation of the AIS-P, it becomes impossible to construct VCAT, and a band (Bandwidth) for data transfer temporally becomes to zero, that is, becomes the state in which data is not passed. Right after the state, in order to detect the failure and notify MST (Member Status)=FAIL by the LCAS, it becomes the state of temporary remove (LCAS temp-RMV). Since constructing of VCAT is restarted from this point, it becomes possible that data is transferred. However, the path in which failure is generated is not used for the VCAT, so that the band is managed under the reduced state than before the failure during the LCAS temp-RMV. The LCAS temp-RMV is maintained during a waiting time WTR (Wait to restore) for calling off the failure state. That is, although failure is restored by switching by the protection of the transmission line after 40 msec of the generation of the AIS-P, the LCAS temp-RMV is still maintained during the waiting time WTR by an LCAS WTR timer. The waiting time WTR is set to about 10 sec in order to avoid excessive failure response, so that a needless band reduced state is continued also after failure restoration.

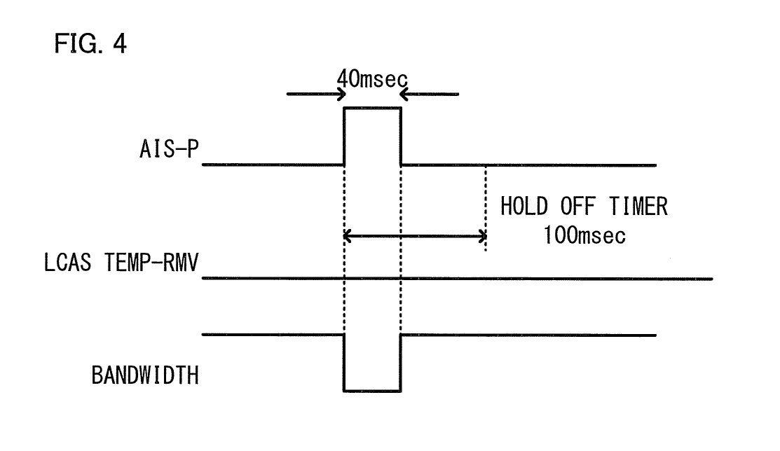

FIG. 4 is a time chart illustrating a service band in the case where there is a protection in a transmission line and an HO timer is applied. The HO timer in the example is set to 100 msec as an example. Similarly to the example of FIG. 3, the state is illustrated in which AIS-P is generated and the failure is restored by switching of path by the protection of the transmission line after 40 msec thereof.

With the generation of AIS-P, it becomes impossible to construct VCAT, and a band for data transfer temporally becomes to zero, that is, it becomes the state in which data is not passed. The LCAS does not notify MST=FAIL not so far as failure is continued over the waiting time of 100 msec by the HO timer, so that the state of the LCAS temp-RMV does not appear during the 100 msec, and it become the waiting state for supposing failure restoration on the transmission line. In the LCAS, since the state of LCAS temp-RMV does not appear, the state in which constructing VCAT is impossible is continued till the transmission line is restored and the band to zero is continued in VCAT. When failure is restored by switching of the path by the protection of the transmission line after 40 msec of the generation of the AIS-P, construction of VCAT is restored with the restoration, and the band is returned to the state before the failure is generated. In this manner, in the case where failure restoration by the transmission line is supposed, a needless failure restoration operation of LCAS may be stopped by the introduction of the HO timer, and a useless reduction of the band may be avoided.

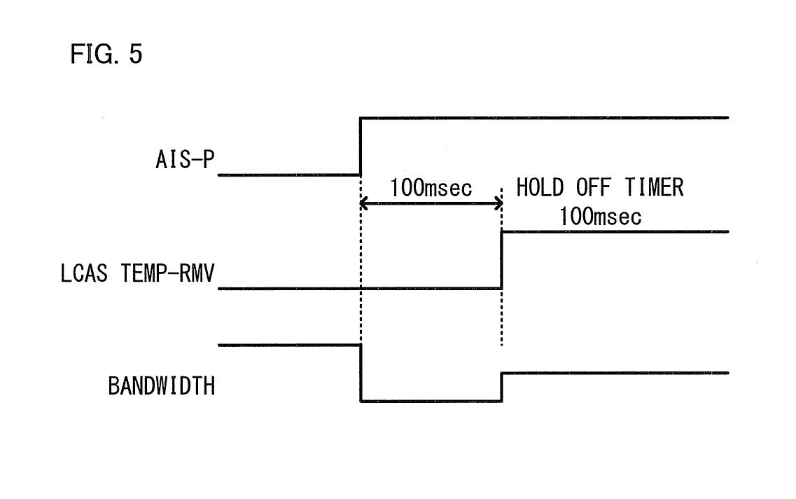

FIG. 5 is a time chart illustrating a service band in the case where there is no protection in a transmission line and an HO timer is applied. That is, FIG. 5 is a diagram for illustrating a problem in the case where the HO timer is applied. In the example, since there is no protection in the transmission line, the case in which failure is not restored is illustrated.

With the generation of AIS-P, it becomes impossible to construct VCAT and a band for data transfer temporally becomes to zero, that is becomes the state in which data is not passed. The LCAS does not notify MST=FAIL not so far as the failure is continued over the time of 100 msec by the HO timer that determines the waiting time for determining failure detection, so that during the 100 msec, the state of LCAS temp-RMV does not appear, and it becomes a waiting state for supposing failure restoration in the transmission line. However, in the example, since there is no protection in the transmission line and failure is not restored, failure is continued over 100 msec. Then, MST=FAIL is notified in accordance with the HO timer in the LCAS, so that it becomes the state of LCAS temp-RMV at the point, and management is executed under the state in which band is reduced as compared with before failure. Accordingly, during 100 msec by the HO timer, the state in which the band is zero, that is, the state in which data is not passed is continued.

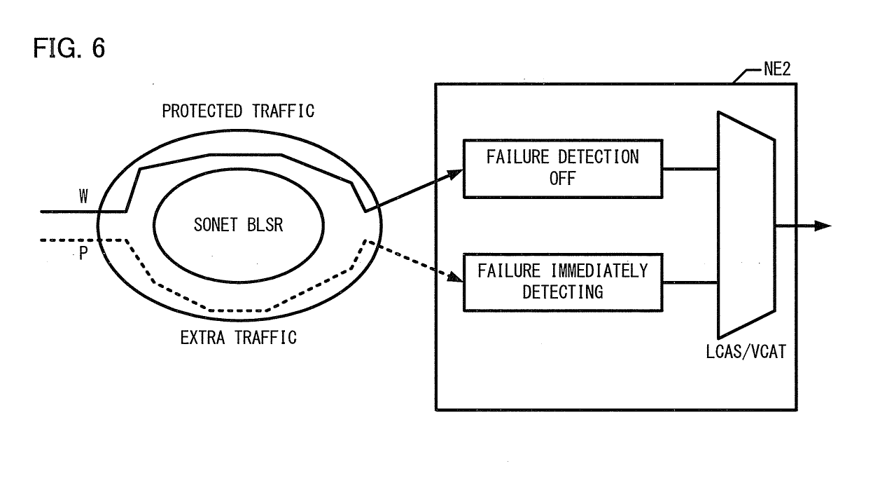

FIG. 6 is a diagram illustrating a setting in the case where a line whose failure is restored and a line whose failure is not restored are used in LCAS in a transmission line of a BLSR (Bidirectional Line Switched Ring) system. That is, in the embodiment, LCAS management is executed through the transmission line in which a ring capable of failure restoration by BLSR on SONET is constituted by applying Telcordia GR (Generic Requirement)-1230-CORE and the like.

In the BLSR, a path which is a target of failure restoration (W of FIG. 6: Protected traffic) and a standby path for failure restoration (P: Extra traffic) are used. The standby path at the P side is used as an alternative path of the W side path when failure is generated, so that the standby path has a property that it becomes impossible to use the P side path when failure restoration is executed at the W side path. Accordingly, in the case where it is not necessary to assure every band, management for increasing the band at normal time is possible by effectively using the standby path line by assigning the P side path as a part of the member of the LCAS.

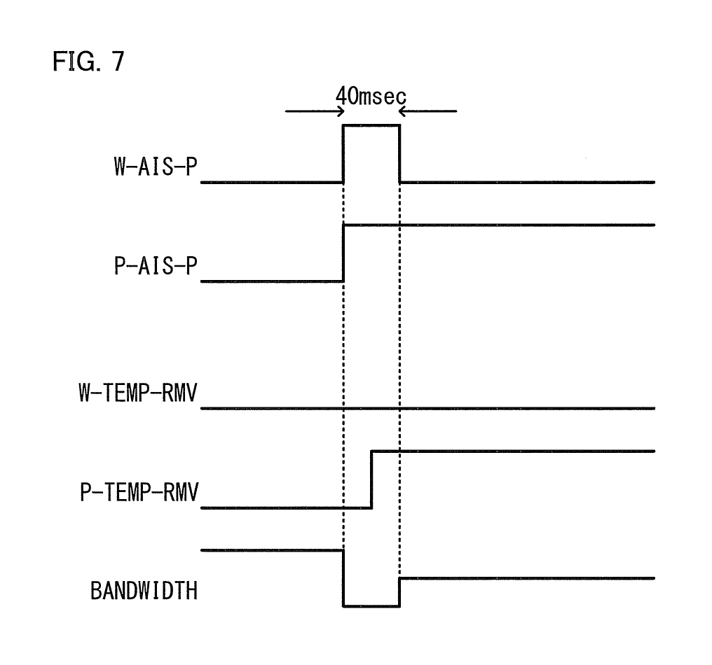

According to the embodiment, it is possible to set a different failure detection condition with respect to a path of a target of failure restoration and a standby path for restoration. For example, in the case of FIG. 6, failure detection is disabled for the W side path which is the transmission line having a protection, and failure detection is activated and the waiting time (HO timer) till failure detection is determined is set to zero for the P side path which is the transmission line having no protection. FIG. 7 illustrates a state of a service band when failure is generated in a transmission line in the case where LCAS member failure detection conditions for every path are set.

FIG. 7 is a time chart illustrating a service band when failure is generated in a transmission line in the network of FIG. 6. Failure is generated in the ring and AIS-P (W-AIS-P, P-AIS-P) is generated at approximately the same time at the both of the transmission line at the W side and the transmission line at the P side. At the time, since failure detection setting is disabled at the W side, the LCAS temp-RMV state does not appear (see W-temp-RMV). On the other hand, since setting is made to immediately detect failure without the HO timer at the P side, it immediately becomes the LCAS-temp-RMV state (see P-temp-RMV). Then, when 40 msec is passed, the failure at the W side is restored and the band before the failure is held, and the P side is used for redundancy relieving of the W side path, so that the state of the failure is continued. As a result, with the failure restoration at the W side, speedy communication of data using the W side becomes possible.

Next, a control related to the protection of the transmission line with respect to excessive bit error and signal degrade of the path will be described. According to GR-1400-CORE, after an excessive bit error (Excessive BER) or a signal degrade (SD condition) is detected, in order to call off the state of the bit error, a waiting time is regulated in order to surely assure restoration and in order not to repeat switching periodically. For example, in the case where the threshold value of the bit error rate is set to 10⁻⁶ in STS-1 (Synchronous Transport Signal level 1) of SONET, the waiting time to transit from the bit error state to the normal state is set to from 10 sec, depending on design, to 20 sec. On the other hand, when the transmission line has a protection, relieving is executed in accordance with an excessive bit error or a signal degrade, and restoration from the bit error is assumed. Although for a short period, AIS-P is temporally generated when path is switched for the relieving, so that transition from the failure state to a normal state is executed at a high speed based on the AIS-P.

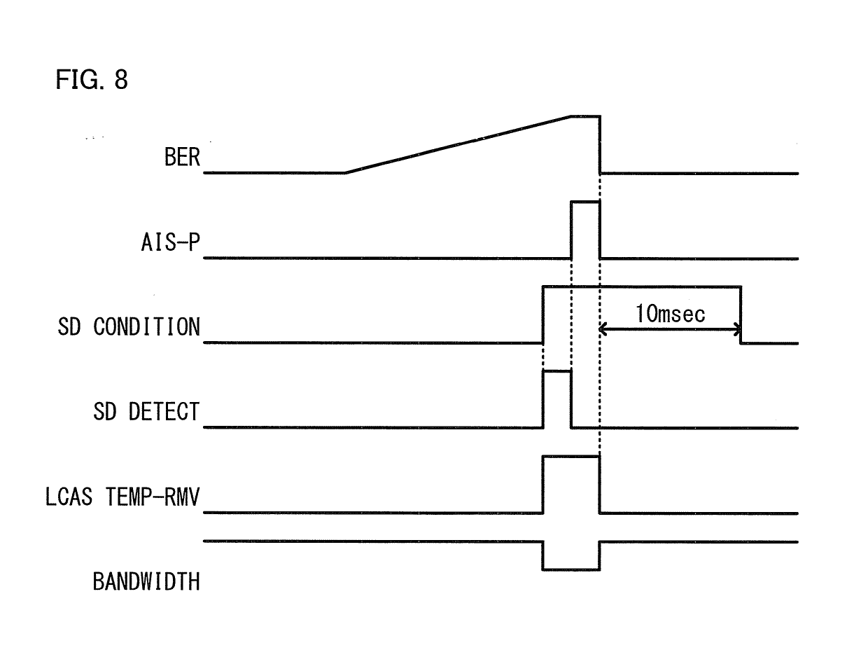

FIG. 8 is a time chart illustrating a service band in the case where a bit error is called off after the bit error is detected. That is, FIG. 8 illustrates a state in the case where fiber degrade, deterioration of an optical transmission component, or the like is occurred in the line presently being used and bit error is gradually increased.

When the bit error is gradually increased and deteriorated to a predetermined threshold value, excessive bit error or signal degrade regulated by GR-1400-CORE is detected by the transmission apparatus at the receiving part which is suitable for LCAS sink. At approximately the same time, excessive bit error or signal degrade is detected also in the transmission line, and switching operation of the path is executed. The signal actually being received by the transmission apparatus of a receiving side is restored to a normal state at the point. However, the state of the excessive bit error or signal degrade regulated by GR-1400-CORE is not immediately called off due to the aforementioned waiting time. Accordingly, if the information is used as failure information of LCAS, LCAS temp-RMV is continued and the state in which the band is reduced is needlessly continued. Consequently, as the failure detection illustrated in FIG. 2, when AIS-P or UNEQ-P is received, it is set that the excessive bit error or the signal degrade is called off.

In FIG. 8, the failure information that is called off by the generation of AIS-P after the signal degrade (SD condition) is detected is illustrated by SD detect. By using the SD detect to the member failure detection conditions of LCAS, the duration time of the LCAS temp-RMV, that is, the time during the band is reduced is limited to the period which is almost impossible to manage in reality.

### Second Embodiment

As a next embodiment, when the transmission apparatus is concerned in the protection of transmission line, it is possible to control a failure restoration operation of LCAS more surely when protection is executed in the transmission apparatus.

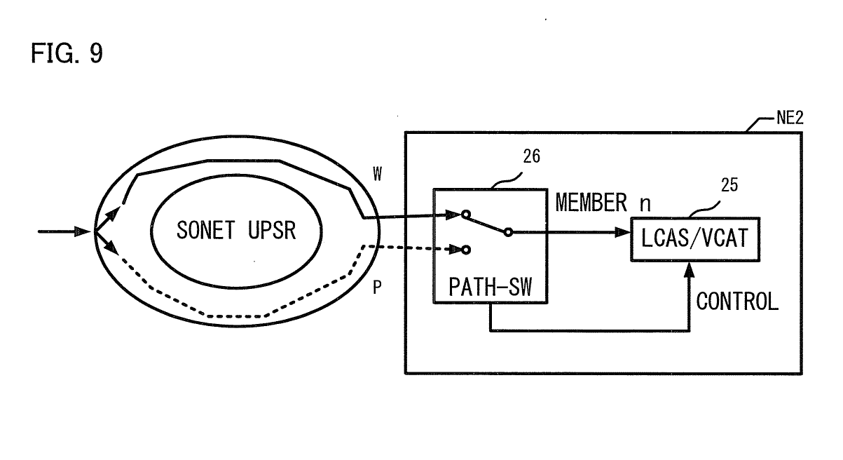

FIG. 9 is a diagram illustrating an example in which a transmission apparatus is involving with a protection of a transmission line. For example, FIG. 9 illustrates control when protection operation is generated in the transmission apparatus at the receiving side when a protection is executed by UPSR (Unidirectional Path Switched Ring) of SONET. Note that in FIG. 9, only 1 member (member n) is illustrated among members of the LCAS. However, the similar control is executed for a plurality of paths. Further, the protection of transmission line is not limited to path switch means such as the UPSR, and another redundancy system may be applied as far as it detects that the protection is executed by the transmission apparatus.

In FIG. 9, a path switch (PATH-SW 26) is provided at the portion at which data is taken out to an LCAS/VCAT unit 25 from the UPSR system, and when failure is detected at the Work side (W) of the UPSR system, PATH-SW 26 is switched to the Protection side (P) of the UPSR system to restore the failure. In the case where such a configuration is included, that the protection processing is executed is surely detected in the transmission apparatus, so that it becomes possible to control the operation related to LCAS by the judgment in the self transmission apparatus.

In such a control, during from when the protection processing is started to when the switching of paths is completed, failure detection of the LCAS member may be temporally automatically stopped. In this case, it is preferable that the starting of the automatic stop is the time when switching conditions are satisfied, and it is preferable that completion of the automatic stop is the time when clear of the path failure is detected after the switching. Also in the control, even when failure restore operation of LCAS is started before automatic stop control is activated, it becomes possible to immediately restore the band transferring data by forcibly awaking the LCAS temp-RMV without waiting the waiting time WTR.

Further, in the case of protection type having a switching protocol as BLSR system, means capable of obtaining that switching is generated in another transmission apparatus and obtaining the state that switching operation is prohibited in another transmission apparatus has been provided. According to GR-1230-CORE, the protection information is notified via a transmission line by using K1/K2 bite or DCC in an overhead of SONET. When it is detected that switching is generated in another transmission apparatus (that is, protection processing of transmission line generating) by using this using K1/K2 bite or DCC, it is possible to control so that failure detection of the LCAS member is temporally automatically stopped in the self transmission apparatus. In this case, it is preferable that the starting of the automatic stop is the time when generation of switching is detected, and it is preferable that the completion of the automatic stop is the time when detected that there is no path failure after the switching. Also with the control, it becomes possible to forcibly awake the LCAS temp-RMV without waiting the waiting time WTR and obtain restoration of the band immediately even when the failure restore operation of LCAS is started before auto stop control is activated.

In the case of the embodiment, the information that the path that is supposed of failure restoration by the protection processing is not switched (that is, excluded from switching target) may be recognized for utilization. That is, when it is detected that executing of protection processing of the transmission line is presently prohibited by the protection information, it becomes possible to automatically execute the management in which failure restoration by the LCAS is valid without using the HO timer for the appropriate path as a path having no protection on a temporary basis. Note that the protection processing of the transmission line is not limited to the BLSR means, and another redundancy system may be applied as far as the state related to the protection operation of another apparatus is collected.

Next, a processing when the entire network including LCAS is set up will be described.

When LCAS is used for managing the path such as SONET system by a regulation unit, when entire transmission line is set up, path on the transmission line is to be set up one by one. Accordingly, paths for the member of LCAS may be gradually opened. Further, in order to assure redundancy of the transmission line, there is also a case that a part of the paths in the LCAS is formed to connect via a route geographically different from another path, and there is also a case that the management company having a backbone (trunk line) is different. In this case, there appears a large difference in terms of time till path is opened between a plurality of paths that are finally supposed of failure restoration by the protection processing of the transmission line.

According to the embodiment, it is also possible to execute management in which the path that is not opened is excluded from the member during the period from when management is started to when path is opened by setting failure detection to be valid with respect to every member. Herewith, also in the state in which a part of path is not opened, it is possible to prevent that the LCAS control in which protection processing of transmission line is expected causes a bad influence in the management of path. When the path is opened in reality, it is judged that failure is restored in the LCAS, and the failure state of the path is called off. Accordingly, the original purpose is also automatically attained by appropriately setting member failure detection conditions at the time. The timing for automatically transiting the member failure detection conditions to a predetermined state may be the time right after failure restoration. Alternatively, the timing may be the time after an automatic service starting period (GR-1093: Automatic In-Service Provisioning) that is determined for every apparatus. It is suitable for the original purpose described above to control the operation related to failure restoration of LCAS so as to depend on a protection processing of the transmission line.

According to the transmission apparatus described above, since detection conditions of failure are changed for every path of member, it is possible to set conditions in accordance with the circumstance of the path. For example, failure detection of LCAS is disabled as for the path of the transmission line having a protection processing, whereas failure detection of LCAS is determined without using an OH timer as for the path of the transmission line having no protection processing. Accordingly, it becomes possible to control the operation related to failure restoration of LCAS so as to depend on a protection processing of the transmission line, useless band reduction of a service band according to data transfer may be excluded, and performance of network may be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A transmission apparatus being operable to realize an LCAS between a plurality of nodes forming a network over which signals are transmitted by using a VCAT system, the transmission apparatus comprising:
a receiving part being operable to detect a failure of a member as a transmission path forming a VCG in each member; and
a controller being operable to control setting of detection conditions of the failure received at the receiving part in each member.

2. The transmission apparatus according to claim 1, wherein the receiving part is operable to set the detection conditions in each type of failure including an AIS-P, a UNE-P, a PLM-P, a TIM-P, an excessive bit error of a path, a signal degrade of a path, a LOM, and an MND.

3. The transmission apparatus according to claim 2, wherein the controller is operable to control a setting of a waiting time for determining failure detection in each member.

4. The transmission apparatus according to claim 3, wherein the controller is operable to deactivate the failure before the waiting time for determining failure detection when detecting one of the AIS-P and the UNE-P after detecting one of the excessive bit error of a path and the signal degrade of a path.

5. The transmission apparatus according to claim 1, wherein the controller is operable to stop detecting the failure of the member corresponding to protection of transmission line when the protection of transmission line had in the transmission apparatus is executed.

6. The transmission apparatus according to claim 3, wherein the controller is operable to deactivate the failure before the waiting time for determining failure detection when protection of transmission line had in the transmission apparatus is executed.

7. The transmission apparatus according to claim 5, wherein the transmission apparatus has an UPSR system as the protection of transmission line.

8. The transmission apparatus according to claim 6, wherein the transmission apparatus has an UPSR system as the protection of transmission line.

9. The transmission apparatus according to claim 1, wherein the controller is operable to stop detecting the failure of the member corresponding to protection of transmission line when the receiving part receives information which the other transmission apparatus over the network transmits so as to execute the protection of transmission line.

10. The transmission apparatus according to claim 3, wherein the controller is operable to deactivate the failure before the waiting time for determining failure detection when the receiving part receives information which the other transmission apparatus over the network transmits so as to execute the protection of transmission line.

11. The transmission apparatus according to claim 3, wherein the controller is operable to set the waiting time for determining failure detection to 0.

12. The transmission apparatus according to claim 9, wherein the transmission apparatus has a BLSR system as the protection of transmission line.

13. The transmission apparatus according to claim 10, wherein the transmission apparatus has a BLSR system as the protection of transmission line.

14. The transmission apparatus according to claim 11, wherein the transmission apparatus has a BLSR system as the protection of transmission line.

15. The transmission apparatus according to claim 1, wherein the controller is operable to control the setting of detection conditions of the failure to be valid with respect to every member when transmission lines are introduced on the network, and whenever there is a member whose failure is restored, the controller is operable to control the setting of detection conditions of the failure for the member.
